(19) United States
(12) Patent Application Publication
(10) Pub. No.: US 2020/0130655 A1
(43) Pub. Date: Apr. 30, 2020

(54) VEHICLE BRAKING DEVICE

(71) Applicant: ADVICS CO., LTD., Kariya-shi, Aichi-ken (JP)

(72) Inventors: Kosuke HASHIMOTO, Kariya-shi, Aichi-ken (JP); Daisuke NAKATA, Seto-shi, Aichi-ken (JP)

(73) Assignee: ADVICS CO., LTD., Kariya-shi, Aichi-ken (JP)

(21) Appl. No.: 16/493,915

(22) PCT Filed: Mar. 26, 2018
(86) PCT No.: PCT/JP2018/012215

§ 371 Date: Sep. 13, 2019

(30) Foreign Application Priority Data
Mar. 27, 2017 (JP) 2017-060921

(51) Int. Cl. B60T 7/18; B60T 13/66; B60T 13/12

(52) U.S. Cl. CPC B60T 7/18; B60T 13/12; B60T 13/66

(57) ABSTRACT

The present invention includes: a normal control unit that performs, on the basis of a target master pressure and an actual-master-pressure correlation value correlated with an actual master pressure value, pressure increasing control, which is control to increase the master pressure, maintaining control, which is control to maintain the master pressure, or pressure reducing control, which is control to reduce the master pressure; a drive suppression unit that performs drive suppression control to suppress driving of master pistons when the actual-master-pressure correlation value approaches the target master pressure while the normal control unit is performing the pressure increasing control or the pressure reducing control; and a suppression-level setting unit that is configured to include wheel cylinders and that sets a suppression level for drive suppression control on the basis of the rigidity of a downstream part, which is closer to the wheel cylinders than master chambers.

### TECHNICAL FIELD

The present invention relates to a vehicle braking device.

### BACKGROUND ART

As a vehicle braking device, that which generates wheel pressure in a plurality of wheel cylinders connected to a master chamber of a master cylinder by driving a master piston of the master cylinder is known. For example, Japanese Unexamined Patent Application Publication No. 2015-182639 discloses a vehicle braking device in which a master piston is driven by a force corresponding to the pressure in the servo chamber (servo pressure). This vehicle braking device is configured to execute a gradient limitation control when determining that the gradient of the servo pressure corresponding to the master pressure should be limited. The occurrence of overshoot and undershoot thus can be suppressed.

### CITATIONS LIST

### Patent Literature

Patent Literature 1: Japanese Unexamined Patent Application Publication No. 2015-182639

### SUMMARY OF INVENTION

### Technical Problems

Here, the inventor focused on drive of the master piston, improved the vehicle braking device, and developed a new device that brings the control target pressure such as the master pressure and the wheel pressure closer to the target pressure more accurately. The present invention has been made in view of such circumstances, and it is an object of the present invention to provide a vehicle braking device capable of bringing a control target pressure closer to a target pressure with high accuracy.

### Solutions to Problems

A vehicle braking device of the present invention is a vehicle braking device that drives a master piston of a master cylinder to generate wheel pressure in a plurality of wheel cylinders connected to a master chamber of the master cylinder, the vehicle braking device including a normal control unit that executes a pressure increasing control that is a control of increasing the master pressure, a maintaining control that is a control of maintaining the master pressure, or a pressure reducing control that is a control of reducing the master pressure based on an actual-master-pressure correlation value correlated with an actual value of a master pressure that is a pressure in the master chamber and a target master pressure that is a target value of the actual-master-pressure correlation value; a drive control unit that executes a drive suppression control for suppressing drive of the master piston when the actual-master-pressure correlation value approaches the target master pressure while the normal control unit is executing the pressure increasing control or the pressure reducing control; and a suppression-level setting unit that sets a suppression level in the drive suppression control based on a rigidity of a downstream part that is a part on the wheel cylinder side than the master chamber configured to include the wheel cylinder.

### Advantageous Effects of Invention

The drive of the master piston changes the wheel pressures of the plurality of wheel cylinders connected to the master chamber. Here, in the pressure increasing control in a state where the rigidity of the downstream part is low, it is conceivable that the wheel pressure of each wheel cylinder may be different as the change in wheel pressure with respect to the fluid amount of the operation fluid sent from the master chamber to the plurality of wheel cylinders differs in each wheel cylinder. Therefore, when the movement of the master piston is stopped during the control, the master pressure is not increased and the volume of the downstream part is relatively easily increased, and hence the wraparound of the operation fluid is likely to occur among the plurality of wheel cylinders communicated through the master chamber. As a result, there is a possibility that the wheel pressure of the wheel cylinder which is a relatively high pressure may be reduced. Furthermore, the master pressure may decrease due to the situation where the master piston is stopped and the volume of the downstream part is relatively easily increased, and thus the pressure increasing control may be executed again for its recovery and the control hunting may occur. Similarly, in the pressure reducing control when the rigidity of the downstream part is low, when the movement of the master piston is stopped, the pressure adjustment of the wheel pressure may be adversely affected.

However, according to the present invention, since the suppression level is set based on the rigidity of the downstream part, the movement of the master piston can be adjusted according to the rigidity, and adverse effects on the control such as wraparound, control hunting, and the like can be suppressed. That is, according to the present invention, the drive suppression control corresponding to the situation of the downstream part is executed, the rapid change in the control target pressure such as the wheel pressure is suppressed, and the control target pressure can be brought close to the target pressure with high accuracy.

### BRIEF DESCRIPTION OF DRAWINGS

FIG. 1 is a configuration view showing a configuration of a vehicle braking device according to a first embodiment.

FIG. 2 is a cross-sectional view showing the detailed configuration of a regulator according to the first embodiment.

FIG. 3 is a time chart describing a gradient limitation control (drive suppression control) according to the first embodiment.

FIG. 4 is a flowchart explaining the gradient limitation control (drive suppression control) according to the first embodiment.

FIG. 5 is an explanatory view describing a rigidity of a wheel cylinder.

FIG. 6 is a time chart describing a detailed drive suppression control according to the first embodiment.

FIG. 7 is a flowchart explaining the detailed drive suppression control according to the first embodiment.

FIG. 8 is an explanatory view explaining a hysteresis current according to a fifth embodiment.

FIG. 9 is an explanatory view explaining gradient limitation control according to a sixth embodiment.

### DESCRIPTION OF EMBODIMENTS

Hereinafter, a braking device in accordance with an embodiment of the present invention will be described based on the drawings. In each of the drawings used for explanation, the shape and size of each part may not necessarily be exact.

### First Embodiment

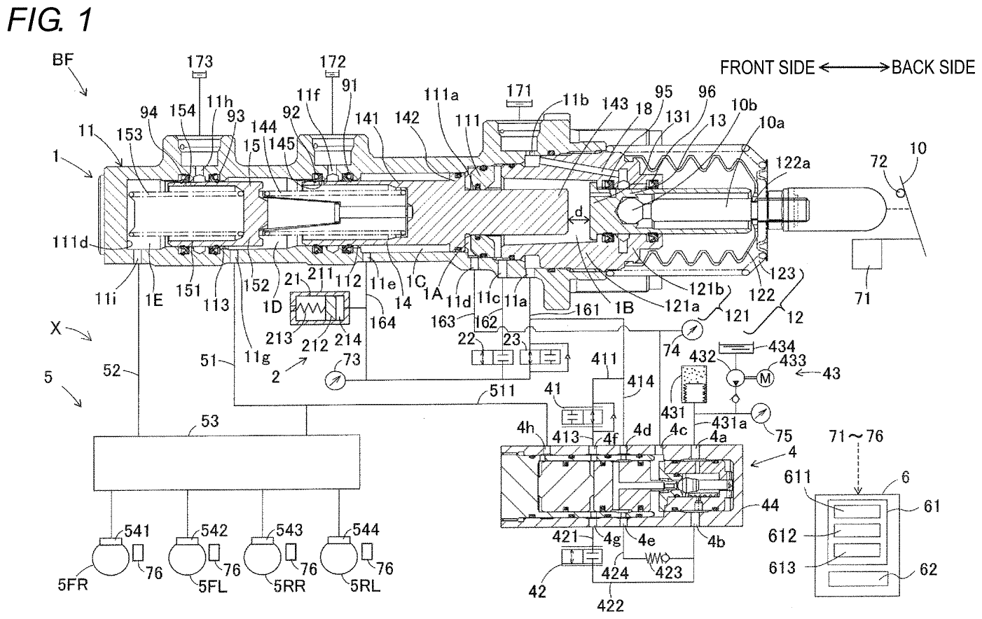

As shown in FIG. 1, the braking device includes a fluid pressure braking force generator BF that generates fluid pressure braking force at the wheels 5FR, 5FL, 5RR, and 5RL, and a brake ECU 6 that controls the fluid pressure braking force generator BF.

### (Fluid Pressure Braking Force Generator BF)

The fluid pressure braking force generator BF is configured by a master cylinder 1, a reaction force generator 2, a first control valve 22, a second control valve 23, a servo pressure generator 4, a fluid pressure control unit 5, and various sensors 71 to 76 and the like.

### (Master Cylinder 1)

The master cylinder 1 is a part that supplies operation fluid (brake fluid) to the fluid pressure control unit 5 in accordance with the operation amount of a brake pedal 10, and is configured by a main cylinder 11, a cover cylinder 12, an input piston 13, a first master piston 14, a second master piston 15 and the like. The brake pedal 10 merely needs to be a brake operating means that is brake operable by a driver. Furthermore, one master piston may be provided.

The main cylinder 11 is a bottomed, substantially cylindrical housing that is closed on the front side and opened on the back side. An inner wall portion 111 that projects out in an inward flange shape is provided closer to the back side on the inner peripheral side of the main cylinder 11. The center of the inner wall portion 111 is a through hole 111a penetrating in the front and back direction. Furthermore, on the front side of the inner wall portion 111 inside the main cylinder 11, smaller diameter parts 112 (back side) and 113 (front side), which inner diameters are slightly smaller, are provided. That is, the smaller diameter parts 112 and 113 project out in an inward annular shape from the inner peripheral surface of the main cylinder 11. The first master piston 14 is disposed inside the main cylinder 11 to slidably contact the smaller diameter part 112 and to be movable in the axial direction. Similarly, the second master piston 15 is disposed to slidably contact the smaller diameter part 113 and to be movable in the axial direction.

The cover cylinder 12 is configured by a substantially cylindrical cylinder portion 121, a bellows tubular boot 122, and a cup-shaped compression spring 123. The cylinder portion 121 is disposed on the back end side of the main cylinder 11 and coaxially fitted to an opening on the back side of the main cylinder 11. The inner diameter of a front part 121a of the cylinder portion 121 is larger than the inner diameter of the through hole 111a of the inner wall portion 111. Furthermore, the inner diameter of a back part 121b of the cylinder portion 121 is smaller than the inner diameter of the front part 121a.

A dustproof boot 122 has a bellows tubular shape and can be expanded and contracted in the front and back direction, and is assembled to contact the back end side opening of the cylinder portion 121 with the front side thereof. A through hole 122a is formed at the center of the back side of the boot 122. The compression spring 123 is a coil-like biasing member disposed around the boot 122, where the front side abuts to the back end of the main cylinder 11, and the back side is diameter reduced to approach the through hole 122a of the boot 122. The back end of the boot 122 and the back end of the compression spring 123 are coupled to an operation rod 10a. The compression spring 123 biases the operation rod 10a toward the back side.

The input piston 13 is a piston that slidably moves within the cover cylinder 12 according to the operation of the brake pedal 10. The input piston 13 is a bottomed substantially cylindrical piston having a bottom surface on the front side and an opening on the back side. A bottom wall 131 forming the bottom surface of the input piston 13 has a larger diameter than other parts of the input piston 13. The input piston 13 is disposed to be axially slidable and liquid tightly on the back part 121b of the cylinder portion 121, and the bottom wall 131 is entered to the inner peripheral side of the front part 121a of the cylinder portion 121.

The operation rod 10a that cooperatively operates with the brake pedal 10 is disposed inside the input piston 13. A pivot 10b at the distal end of the operation rod 10a can push the input piston 13 forward. The back end of the operation rod 10a projects out to the outside through the opening on the back side of the input piston 13 and the through hole 122a of the boot 122 and is connected to the brake pedal 10. When the brake pedal 10 is depressed, the operation rod 10a moves forward while pushing the boot 122 and the compression spring 123 in the axial direction. The input piston 13 also moves forward in cooperation with the forward movement of the operation rod 10a.

The first master piston 14 is disposed to be axially slidable on the inner wall portion 111 of the main cylinder 11. The first master piston 14 is integrally formed with a pressurizing tube portion 141, a flange portion 142, and a projecting portion 143 in order from the front side. The pressurizing tube portion 141 is formed to a bottomed substantially cylindrical shape having an opening on the front side, has a gap formed with the inner peripheral surface of the main cylinder 11, and is in sliding contact with the smaller diameter part 112. A coil-shaped biasing member 144 is disposed in between the second master piston 15 in an internal space of the pressurizing tube portion 141. The first master piston 14 is biased toward the back side by the biasing member 144. In other words, the first master piston 14 is biased by the biasing member 144 toward a set initial position.

The flange portion 142 has a larger diameter than the pressurizing tube portion 141 and is in sliding contact with the inner peripheral surface of the main cylinder 11. The projecting portion 143 has a smaller diameter than the flange portion 142 and is disposed to liquid tightly slide into the through hole 111a of the inner wall portion 111. The back end of the projecting portion 143 passes through the through hole 111a and projects out into the internal space of the cylinder portion 121, and is separated from the inner peripheral surface of the cylinder portion 121. A back end face of the projecting portion 143 is configured to be spaced apart from the bottom wall 131 of the input piston 13 so that its separation distance d can be changed.

Here, a “first master chamber 1D” is defined by the inner peripheral surface of the main cylinder 11, the front side of the pressurizing tube portion 141 of the first master piston 14, and the back side of the second master piston 15. Furthermore, a rear chamber on the back side of the first master chamber 1D is defined by the inner peripheral surface (inner peripheral portion) of the main cylinder 11, the smaller diameter part 112, the front surface of the inner wall portion 111, and the outer peripheral surface of the first master piston 14. The front end and the back end of the flange portion 142 of the first master piston 14 divide the rear chamber to the front and the back, where a “second fluid pressure chamber 1C” is defined on the front side, and a “servo chamber (output chamber) 1A” is defined on the back side. Furthermore, a “first fluid pressure chamber 1B” is defined by the inner peripheral portion of the main cylinder 11, the back surface of the inner wall portion 111, the inner peripheral surface (inner peripheral portion) of the front part 121a of the cylinder portion 121, the projecting portion 143 (back end) of the first master piston 14, and the front end of the input piston 13.

The second master piston 15 is disposed on the front side of the first master piston 14 in the main cylinder 11 to slidably contact the smaller diameter part 113 and to be axially movable. The second master piston 15 is integrally formed with a tubular pressurizing tube portion 151 having an opening on the front side, and a bottom wall 152 that closes the back side of the pressurizing tube portion 151. The bottom wall 152 journals the biasing member 144 between itself and the first master piston 14. A biasing member 153 in the form of a coil spring is disposed in the internal space of the pressurizing tube portion 151 in between the closed inner bottom surface 111d of the main cylinder 11. The second master piston 15 is biased toward the back side by the biasing member 153. In other words, the second master piston 15 is biased by the biasing member 153 toward the set initial position. A “second master chamber 1E” is defined by the inner peripheral surface of the main cylinder 11, the inner bottom surface 111d, and the second master piston 15.

The master cylinder 1 is formed with ports 11a to 11i that communicate the inside with the outside. The port 11a is formed on the back side of the inner wall portion 111 of the main cylinder 11. The port 11b is formed facing the port 11a at a similar position in the axial direction as the port 11a. The port 11a and the port 11b communicate through an annular space between the inner peripheral surface of the main cylinder 11 and the outer peripheral surface of the cylinder portion 121. The port 11a and the port 11b are connected to a pipe 161 and connected to a reservoir 171.

The port 11b is in communication with the first fluid pressure chamber 1B by a passage 18 formed in the cylinder portion 121 and the input piston 13. The passage 18 is shut off when the input piston 13 moves forward, so that the first fluid pressure chamber 1B and the reservoir 171 are shut off.

The port 11c is formed on the back side of the inner wall portion 111 and on the front side of the port 11a, and communicates the first fluid pressure chamber 1B and a pipe 162. The port 11d is formed on the front side of the port 11c, and communicates the servo chamber 1A and a pipe 163. The port 11e is formed on the front side of the port 11d, and communicates the second fluid pressure chamber 1C and a pipe 164.

The port 11f is formed between seal members 91 and 92 of the smaller diameter part 112, and communicates the reservoir 172 and the inside of the main cylinder 11. The port 11f is in communication with the first master chamber 1D through a passage 145 formed in the first master piston 14. The passage 145 is formed at a position where the port 11f and the first master chamber 1D are shut off when the first master piston 14 moves forward. The port 11g is formed on the front side of the port 11f, and communicates the first master chamber 1D and a pipe 51.

The port 11h is formed between seal members 93 and 94 of the smaller diameter part 113, and communicates the reservoir 173 with the inside of the main cylinder 11. The port 11h is in communication with the second master chamber 1E through a passage 154 formed in the pressurizing tube portion 151 of the second master piston 15. The passage 154 is formed at a position where the port 11h and the second master chamber 1E are shut off when the second master piston 15 moves forward. The port 11i is formed on the front side of the port 11h, and communicates the second master chamber 1E and a pipe 52.

Furthermore, in the master cylinder 1, a seal member (black circle in the drawing) such as an O-ring is appropriately disposed. The seal members 91 and 92 are disposed in the smaller diameter part 112 and are liquid tightly abutted to the outer peripheral surface of the first master piston 14. Similarly, the seal members 93 and 94 are disposed in the smaller diameter part 113 and are liquid tightly abutted to the outer peripheral surface of the second master piston 15. Furthermore, seal members 95 and 96 are also disposed between the input piston 13 and the cylinder portion 121.

The stroke sensor 71 is a sensor that detects an operation amount (stroke amount) at which the brake pedal 10 is operated by the driver, and transmits a detection signal to the brake ECU 6. A brake stop switch 72 is a switch for detecting the presence or absence of the operation of the brake pedal 10 by the driver as a binary signal, and transmits a detection signal to the brake ECU 6.

### (Reaction Force Generator 2)

The reaction force generator 2 is a device that generates a reaction force that opposes the operation force when the brake pedal 10 is operated, and is mainly configured by the stroke simulator 21. The stroke simulator 21 generates a reaction force fluid pressure in the first fluid pressure chamber 1B and the second fluid pressure chamber 1C in accordance with the operation of the brake pedal 10. The stroke simulator 21 is configured by slidably fitting a piston 212 to a cylinder 211. The piston 212 is biased forward by the compression spring 213, and a reaction force fluid pressure chamber 214 is formed on the front surface side of the piston 212. The reaction force fluid pressure chamber 214 is connected to the second fluid pressure chamber 1C through the pipe 164 and the port 11e, and furthermore, the reaction force fluid pressure chamber 214 is connected to the first control valve 22 and the second control valve 23 through the pipe 164.

### (First Control Valve 22)

The first control valve 22 is an electromagnetic valve having a structure of being closed in a non-energized state, and the opening and closing of the first control valve 22 are controlled by the brake ECU 6. The first control valve 22 is connected between the pipe 164 and the pipe 162. Here, the pipe 164 is communicated to the second fluid pressure chamber 1C through the port 11e, and the pipe 162 is communicated to the first fluid pressure chamber 1B through the port 11c. When the first control valve 22 is opened, the first fluid pressure chamber 1B is in an opened state, and when the first control valve 22 is closed, the first fluid pressure chamber 1B is in a sealed state. Therefore, the pipe 164 and the pipe 162 are provided to connect the first fluid pressure chamber 1B and the second fluid pressure chamber 1C.

The first control valve 22 is closed in a non-energized state in which current is not flowed, and at this time, the first fluid pressure chamber 1B and the second fluid pressure chamber 1C are shut off. As a result, the first fluid pressure chamber 1B is sealed and there is no place for the operation fluid to move, and the input piston 13 and the first master piston 14 move in cooperation with each other while maintaining a constant separation distance d. Furthermore, the first control valve 22 is opened in the energized state in which current is flowed, and at this time, the first fluid pressure chamber 1B and the second fluid pressure chamber 1C are communicated. Thus, the change in volume of the first fluid pressure chamber 1B and the second fluid pressure chamber 1C involved in the forward and backward movement of the first master piston 14 is absorbed by the movement of the operation fluid.

The pressure sensor 73 is a sensor that detects the reaction force fluid pressure of the second fluid pressure chamber 1C and the first fluid pressure chamber 1B, and is connected to the pipe 164. The pressure sensor 73 detects the pressure in the second fluid pressure chamber 1C when the first control valve 22 is in a closed state, and also detects the pressure of the communicated first fluid pressure chamber 1B when the first control valve 22 is in an opened state. The pressure sensor 73 transmits the detection signal to the brake ECU 6.

### (Second Control Valve 23)

The second control valve 23 is an electromagnetic valve having a structure of being opened in a non-energized state, and the opening and closing of the second control valve 23 are controlled by the brake ECU 6. The second control valve 23 is connected between the pipe 164 and the pipe 161. Here, the pipe 164 is communicated with the second fluid pressure chamber 1C through the port 11e, and the pipe 161 is communicated with the reservoir 171 through the port 11a. Therefore, the second control valve 23 communicates the second fluid pressure chamber 1C and the reservoir 171 in the non-energized state so as not to generate the reaction force fluid pressure, and shuts off the second fluid pressure chamber and the reservoir in the energized state to generate the reaction force fluid pressure.

### (Servo Pressure Generator 4)

The servo pressure generator 4 includes a pressure reducing valve (pressure reducing electromagnetic valve) 41, a pressure increasing valve (pressure increasing electromagnetic valve) 42, a pressure supplying unit 43, a regulator 44, and the like. The pressure reducing valve 41 is an electromagnetic valve having a structure of being opened in a non-energized state, and the flow rate is controlled by the brake ECU 6. One side of the pressure reducing valve 41 is connected to the pipe 161 through a pipe 411, and the other side of the pressure reducing valve 41 is connected to a pipe 413. That is, one side of the pressure reducing valve 41 is in communication with the reservoir (low pressure source) 171 through the pipes 411 and 161 and the ports 11a and 11b. The pipe 411 may be connected not to the reservoir 171 but to a reservoir 434 described later. In this case, the reservoir 434 corresponds to a low pressure source. Furthermore, the reservoir 171 and the reservoir 434 may be the same reservoir.

The pressure increasing valve 42 is an electromagnetic valve having a structure of being closed in a non-energized state, and the flow rate is controlled by the brake ECU 6. One side of the pressure increasing valve 42 is connected to a pipe 421, and the other side of the pressure increasing valve 42 is connected to a pipe 422. The pressure reducing valve 41 and the pressure increasing valve 42 correspond to a pilot fluid pressure generator. The pressure reducing valve 41 and the pressure increasing valve 42 are differential pressure type electromagnetic valves whose valve opening current is determined by the differential pressure between one side (inlet) and the other side (outlet).

The pressure supplying unit 43 is a part that mainly supplies a high pressure operation fluid to the regulator 44. The pressure supplying unit 43 is configured by an accumulator (high pressure source) 431, a fluid pressure pump 432, a motor 433, the reservoir 434 and the like.

The accumulator 431 is a tank that accumulates high pressure operation fluid. The accumulator 431 is connected to the regulator 44 and the fluid pressure pump 432 by a pipe 431a. The fluid pressure pump 432 is driven by the motor 433 and pressure feeds the operation fluid stored in the reservoir 434 to the accumulator 431. The pressure sensor 75 provided in the pipe 431a detects an accumulator fluid pressure of the accumulator 431 and transmits a detection signal to the brake ECU 6. The accumulator fluid pressure is correlated to the accumulation amount of the operation fluid accumulated in the accumulator 431.

When the pressure sensor 75 detects that the accumulator fluid pressure dropped to less than or equal to a predetermined value, the motor 433 is driven based on the command from the brake ECU 6. Thus, the fluid pressure pump 432 pressure feeds the operation fluid to the accumulator 431 to recover the accumulator fluid pressure to greater than or equal to a predetermined value.

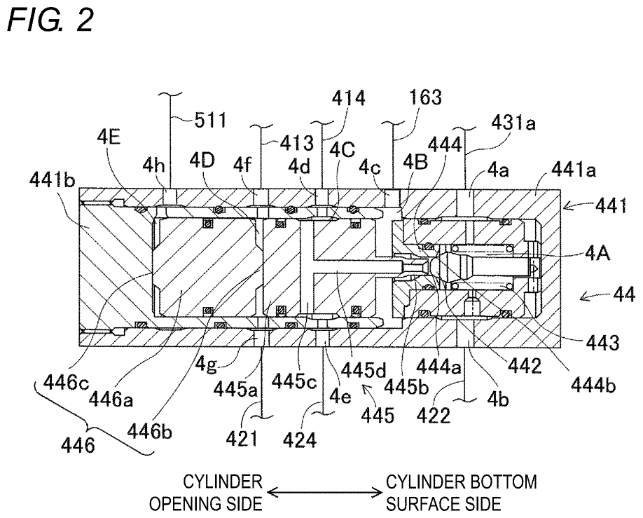

As shown in FIG. 2, the regulator (pressure regulating device) 44 includes a cylinder 441, a ball valve 442, a biasing unit 443, a valve seat 444, a control piston 445, a sub piston 446, and the like.

The cylinder 441 is configured by a substantially bottomed cylindrical cylinder case 441a having a bottom surface on one side (right side in the drawing), and a lid member 441b that closes an opening (left side in the drawing) of the cylinder case 441a. The cylinder case 441a is formed with a plurality of ports 4a to 4h that communicate the inside with the outside. The lid member 441b is also formed to a substantially bottomed cylindrical shape, and each port is formed at each part facing the plurality of ports 4a to 4h of the tubular portion.

The port 4a is connected to the pipe 431a. The port 4b is connected to the pipe 422. The port 4c is connected to the pipe 163. The pipe 163 connects the servo chamber 1A and the output port 4c. The port 4d is connected to the pipe 161 through the pipe 414. The port 4e is connected to the pipe 424 and is further connected to the pipe 422 through a relief valve 423. The port 4f is connected to the pipe 413. The port 4g is connected to the pipe 421. The port 4h is connected to a pipe 511 branched from the pipe 51. The pipe 414 may be connected not to the pipe 161 but to the reservoir 434.

The ball valve 442 is a ball-type valve, and is disposed on the bottom surface side (hereinafter also referred to as the cylinder bottom surface side) of the cylinder case 441a inside the cylinder 441. The biasing unit 443 is a spring member for biasing the ball valve 442 toward the opening side (hereinafter also referred to as the cylinder opening side) of the cylinder case 441a, and is installed on the bottom surface of the cylinder case 441a. The valve seat 444 is a wall member provided on the inner peripheral surface of the cylinder case 441a, and defines the cylinder opening side and the cylinder bottom surface side. At the center of the valve seat 444, a through passage 444a is formed which communicates the defined cylinder opening side and the cylinder bottom surface side. The valve seat 444 holds the ball valve 442 from the cylinder opening side such that the biased ball valve 442 blocks the through passage 444a. A valve seat surface 444b on which the ball valve 442 is removably seated (abutted) is formed at the opening on the cylinder bottom surface side of the through passage 444a.

A space defined by the ball valve 442, the biasing unit 443, the valve seat 444, and the inner peripheral surface of the cylinder case 441a on the cylinder bottom surface side is referred to as a “first chamber 4A”. The first chamber 4A is filled with operation fluid, and connected to the pipe 431a through the port 4a and connected to the pipe 422 through the port 4b.

The control piston 445 includes a substantially circular column shaped main body portion 445a and a substantially circular column shaped projecting portion 445b smaller in diameter than the main body portion 445a. The main body portion 445a is disposed to be axially slidable coaxially and liquid-tightly on the cylinder opening side of the valve seat 444 in the cylinder 441. The main body portion 445a is biased toward the cylinder opening side by a biasing member (not shown). A passage 445c extending in the radial direction (up and down direction in the drawing), both ends of which being opened to the peripheral surface of the main body portion 445a, is formed substantially in the center in the cylinder axial direction of the main body portion 445a. The inner peripheral surface of a portion of the cylinder 441 corresponding to the open position of the passage 445c is formed with the port 4d and depressed to a concave shape. This depressed space is referred to as a “third chamber 4C”.

The projecting portion 445b projects out from the center of the end face on the cylinder bottom surface side of the main body portion 445a toward the cylinder bottom surface side. The diameter of the projecting portion 445b is smaller than the through passage 444a of the valve seat 444. The projecting portion 445b is disposed coaxially with the through passage 444a. The distal end of the projecting portion 445b is spaced apart from the ball valve 442 by a predetermined interval toward the cylinder opening side. The projecting portion 445b is formed with a passage 445d extending in the cylinder axial direction that is opened at the center of the end face in the cylinder bottom surface side of the projecting portion 445b. The passage 445d extends into the main body portion 445a and is connected to the passage 445c.

A space defined by the end face on the cylinder bottom surface side of the main body portion 445a, the outer peripheral surface of the projecting portion 445b, the inner peripheral surface of the cylinder 441, the valve seat 444, and the ball valve 442 is referred to as a “second chamber 4B”. The second chamber 4B is communicated with the ports 4d and 4e through the passages 445d and 445c and the third chamber 4C in a state where the projecting portion 445b and the ball valve 442 are not abutted.

The sub piston 446 includes a sub main body portion 446a, a first projecting portion 446b, and a second projecting portion 446c. The sub main body portion 446a is formed to a substantially circular column shape. The sub main body portion 446a is coaxially and liquid-tightly disposed to be axially slidable on the cylinder opening side of the main body portion 445a in the cylinder 441.

The first projecting portion 446b has a substantially circular column shape with a diameter smaller than that of the sub main body portion 446a, and projects out from the center of the end face on the cylinder bottom surface side of the sub main body portion 446a. The first projecting portion 446b is abutted to the end face on the cylinder opening side of the main body portion 445a. The second projecting portion 446c has the same shape as the first projecting portion 446b, and projects out from the center of the end face on the cylinder opening side of the sub main body portion 446a. The second projecting portion 446c is abutted to the lid member 441b.

A space defined by the end face on the cylinder bottom surface side of the sub main body portion 446a, the outer peripheral surface of the first projecting portion 446b, the end face on the cylinder opening side of the control piston 445, and the inner peripheral surface of the cylinder 441 is referred to as a “first pilot chamber 4D”. The first pilot chamber 4D is in communication with the pressure reducing valve 41 through the port 4f and the pipe 413, and in communication with the pressure increasing valve 42 through the port 4g and the pipe 421.

On the other hand, a space defined by the end face on the cylinder opening side of the sub main body portion 446a, the outer peripheral surface of the second projecting portion 446c, the lid member 441b, and the inner peripheral surface of the cylinder 441 is referred to as a “second pilot chamber 4E”. The second pilot chamber 4E is in communication with the port 11g through the port 4h and the pipes 511 and 51. Each chamber 4A to 4E is filled with operation fluid. The pressure sensor (output pressure acquisition means) 74 is a sensor that detects the servo pressure (output pressure) supplied to the servo chamber 1A, and is connected to the pipe 163. The pressure sensor 74 transmits the detection signal to the brake ECU 6.

Thus, the regulator 44 includes a control piston 445 driven by the difference between the force corresponding to the pressure in the first pilot chamber 4D (also referred to as “pilot pressure”) and the force corresponding to the servo pressure, where when the volume of the first pilot chamber 4D is changed with the movement of the control piston 445 and the flow rate of the liquid flowing into and out of the first pilot chamber 4D is increased, the movement amount of the control piston 445 based on the position of the control piston 445 in an equilibrium state where the force corresponding to the pilot pressure and the force corresponding to the servo pressure are balanced is increased, and the flow rate of the liquid flowing into and out of the servo chamber 1A is increased.

The regulator 44 is configured such that as the flow rate of the liquid flowing from the accumulator 431 into the first pilot chamber 4D increases, the first pilot chamber 4D enlarges and the flow rate of the liquid flowing from the accumulator 431 into the servo chamber 1A increases, and as the flow rate of the liquid flowing out from the first pilot chamber 4D to the reservoir 171 increases, the first pilot chamber 4D reduces and the flow rate of the liquid flowing out from the servo chamber 1A to the reservoir 171 increases.

Furthermore, the control piston 445 includes a damper device Z on a wall portion facing the first pilot chamber 4D. The damper device Z is configured like a stroke simulator, and includes a piston portion biased toward the first pilot chamber 4D by a biasing member. The rigidity of the first pilot chamber 4D changes according to the pilot pressure by providing the damper device Z.

### (Fluid Pressure Control Unit 5)

Wheel cylinders 541 to 544 are communicated with the first master chamber 1D and the second master chamber 1E that generate the master cylinder fluid pressure (master pressure) through the pipes 51 and 52 and the actuator 53. The actuator 53 can also be referred to as an antilock brake system (ABS). The master pressure is the pressure in the first and second master chambers 1D and 1E. The wheel cylinders 541 to 544 form a brake of the wheels 5FR to 5RL. Specifically, a known actuator 53 is connected to the port 11g of the first master chamber 1D and the port 11i of the second master chamber 1E through the pipes 51 and 52, respectively. The wheel cylinders 541 to 544 that operate the brake for braking the wheels 5FR to 5RL are connected to the actuator 53.

The actuator 53 has a wheel speed sensor 76 for detecting the wheel speed provided on each wheel. A detection signal indicating the wheel speed detected by the wheel speed sensor 76 is output to the brake ECU 6. Although not shown because it is known, the actuator 53 includes a plurality of electromagnetic valves, an electric pump, and a reservoir. Furthermore, the actuator 53 is configured by two pipe systems (4 channels). The actuator 53 of the first embodiment includes a first pipe system connecting the second master chamber 1E and the wheel cylinders 541 and 542 through the electromagnetic valve, and a second pipe system connecting the first master chamber 1D and the wheel cylinders 543 and 544 through the electromagnetic valve. At least in the same pipe system, the wheel cylinders 541 and 542 (543, 544) communicate with each other through the master chamber 1D (1E) by opening the electromagnetic valve.

Moreover, in a state where the electromagnetic valves disposed in the flow paths connecting the first and second master chambers 1D and 1E and the wheel cylinders 541 to 544 are opened and in a state where the first and second master pistons 14 and 15 are stopped, when one pipe system has a higher pressure than the other pipe system, the volume of each of the first and second master chambers 1D, 1E increases and decreases, and as a result, the pressure of the high pressure side pipe system may decrease and the pressure of the low pressure side pipe system may rise.

In the actuator 53 configured as described above, the brake ECU 6 switch controls the opening and closing of each holding valve and the pressure reducing valve based on the master pressure (estimated by the servo pressure detected by the pressure sensor 74), the state of the wheel speed, and the longitudinal acceleration, and executes the ABS control (antilock brake control) to adjust the operation fluid pressure applied to each wheel cylinder 541 to 544, that is, the braking force applied to each wheel 5FR to 5RL by operating the motor as necessary. The actuator 53 is a device that supplies the operation fluid supplied from the master cylinder 1 to the wheel cylinders 541 to 544 by adjusting the amount and timing based on the instruction of the brake ECU 6.

In the “brake control” to be described later, the fluid pressure sent from the accumulator 431 of the servo pressure generator 4 is controlled by the pressure increasing valve 42 and the pressure reducing valve 41 and the servo pressure is generated in the servo chamber 1A, whereby the first master piston 14 and the second master piston 15 move forward to pressurize the first master chamber 1D and the second master chamber 1E. The fluid pressure of the first master chamber 1D and the second master chamber 1E is supplied as master pressure from the ports 11g and 11i to the wheel cylinders 541 to 544 through the pipes 51 and 52 and the actuator 53, and the fluid pressure braking force is applied to the wheels 5FR to 5RL.

### (Brake ECU 6)

The brake ECU 6 is an electronic control unit and includes a microcomputer. The microcomputer includes an input/output interface, a CPU, a RAM, a ROM, and a storage unit such as a non-volatile memory, which are connected to one another through a bus.

The brake ECU 6 is connected to various sensors 71 to 76 to control each of the electromagnetic valves 22, 23, 41, 42, the motor 433 and the like. To the brake ECU 6, the operation amount (stroke amount) of the brake pedal 10 by the driver is input from the stroke sensor 71, the presence or absence of the operation of the brake pedal 10 by the driver is input from the brake stop switch 72, the reaction force fluid pressure in the second fluid pressure chamber 1C or the pressure (or reaction force fluid pressure) in the first fluid pressure chamber 1B is input from the pressure sensor 73, the servo pressure supplied to the servo chamber 1A is input from the pressure sensor 74, the accumulator fluid pressure of the accumulator 431 is input from the pressure sensor 75, and the speeds of the respective wheels 5FR, 5FL, 5RR, 5RL are input from the wheel speed sensor 76.

### (Brake Control)

Here, the brake control of the brake ECU 6 will be described. The brake control is normal brake control. That is, the brake ECU 6 energizes and opens the first control valve 22 and energizes and closes the second control valve 23. When the second control valve 23 is closed, the second fluid pressure chamber 1C and the reservoir 171 are shut off, and when the first control valve 22 is opened, the first fluid pressure chamber 1B and the second fluid pressure chamber 1C communicate with each other. Thus, the brake control is in a mode of controlling the pressure reducing valve 41 and the pressure increasing valve 42 to control the servo pressure of the servo chamber 1A while the first control valve 22 is opened and the second control valve 23 is closed. The pressure reducing valve 41 and the pressure increasing valve 42 can also be referred to as a valve device that adjusts the flow rate of the operation fluid flowing into and out of the first pilot chamber 4D. In this brake control, the brake ECU 6 calculates the “required braking force” of the driver from the operation amount of the brake pedal 10 (movement amount of the input piston 13) detected by the stroke sensor 71 or the operation force of the brake pedal 10.

More specifically, when the brake pedal 10 is not depressed, the above-described state, that is, a state in which the ball valve 442 closes the through passage 444a of the valve seat 444 is obtained. Furthermore, the pressure reducing valve 41 is in the opened state, and the pressure increasing valve 42 is in the closed state. That is, the first chamber 4A and the second chamber 4B are isolated.

The second chamber 4B is in communication with the servo chamber 1A through the pipe 163 and is maintained at the same pressure. The second chamber 4B is in communication with the third chamber 4C through the passages 445c and 445d of the control piston 445. Therefore, the second chamber 4B and the third chamber 4C are in communication with the reservoir 171 through the pipes 414 and 161. The first pilot chamber 4D has one side is closed by the pressure increasing valve 42, and the other side communicating with the reservoir 171 through the pressure reducing valve 41. The first pilot chamber 4D and the second chamber 4B are maintained at the same pressure. The second pilot chamber 4E is communicated with the first master chamber 1D through the pipes 511 and 51, and is maintained at the same pressure.

When the brake pedal 10 is depressed from such a state, the brake ECU 6 controls the pressure reducing valve 41 and the pressure increasing valve 42 based on the target friction braking force. That is, the brake ECU 6 controls the pressure reducing valve 41 in the closing direction, and controls the pressure increasing valve 42 in the opening direction.

When the pressure increasing valve 42 is opened, the accumulator 431 and the first pilot chamber 4D communicate with each other. The first pilot chamber 4D and the reservoir 171 are shut off by closing the pressure reducing valve 41. The pressure in the first pilot chamber 4D can be raised by the high pressure operation fluid supplied from the accumulator 431. As the pressure in the first pilot chamber 4D rises, the control piston 445 slides toward the cylinder bottom surface side. As a result, the distal end of the projecting portion 445b of the control piston 445 abuts on the ball valve 442, and the passage 445d is closed by the ball valve 442. Then, the second chamber 4B and the reservoir 171 are shut off.

Furthermore, as the control piston 445 slides on the cylinder bottom surface side, the ball valve 442 is pushed and moved toward the cylinder bottom surface side by the projecting portion 445b, and the ball valve 442 separates from the valve seat surface 444b. Thus, the first chamber 4A and the second chamber 4B communicate with each other by the through passage 444a of the valve seat 444. The high pressure operation fluid is supplied from the accumulator 431 to the first chamber 4A, and the pressure in the second chamber 4B is raised by the communication. As the separation distance of the ball valve 442 from the valve seat surface 444b increases, the flow path of the operation fluid becomes larger, and the fluid pressure in the flow path downstream of the ball valve 442 becomes higher. That is, as the pressure (pilot pressure) in the first pilot chamber 4D increases, the moving distance of the control piston 445 increases, the distance of the ball valve 442 from the valve seat surface 444b increases, and the fluid pressure (servo pressure) in the second chamber 4B becomes higher. The brake ECU 6 controls the pressure increasing valve 42 such that the flow path downstream of the pressure increasing valve 42 becomes larger and controls the pressure reducing valve 41 such that the flow path downstream of the pressure reducing valve 41 becomes smaller so that the pilot pressure in the first pilot chamber 4D becomes higher as the movement amount of the input piston 13 detected by the stroke sensor 71 (operation amount of the brake pedal 10) becomes larger. That is, as the amount of movement of the input piston 13 (amount of operation of the brake pedal 10) increases, the pilot pressure becomes higher and the servo pressure also becomes higher.

As the pressure in the second chamber 4B rises, the pressure in the servo chamber 1A in communication therewith also rises. With the rise in pressure in the servo chamber 1A, the first master piston 14 moves forward, and the pressure in the first master chamber 1D rises. Then, the second master piston 15 also moves forward, and the pressure in the second master chamber 1E rises. With the rise in pressure in the first master chamber 1D, the high-pressure operation fluid is supplied to the actuator 53 and the second pilot chamber 4E to be described later. Although the pressure in the second pilot chamber 4E rises, the pressure in the first pilot chamber 4D similarly rises, and hence the sub piston 446 does not move. Thus, the high pressure (master pressure) operation fluid is supplied to the actuator 53, and the friction brake is operated thus braking the vehicle. The force for moving the first master piston 14 forward in the “brake control” corresponds to the force corresponding to the servo pressure.

When releasing the brake operation, conversely, the pressure reducing valve 41 is opened and the pressure increasing valve 42 is closed, thus communicating the reservoir 171 and the first pilot chamber 4D. Thus, the control piston 445 moves backward and the state returns to the state before the depression of the brake pedal 10.

### (Pressure Increasing Gradient Limitation Control and Pressure Reducing Gradient Limitation Control)

Here, a control for suppressing overshoot and undershoot of the servo pressure, the control being a pressure increasing gradient limitation control that limits a pressure increasing gradient performed during pressure increasing control, and a pressure reducing gradient limitation control that limits a pressure reducing gradient performed during pressure reducing control (hereinafter, generally referred to as “gradient limitation control” or “drive suppression control”) will be described. The brake ECU 6 includes, as functions, a control means 61 that controls the pressure reducing valve 41 and the pressure increasing valve 42 to execute the brake control, and a limitation necessity determination means 62.

The limitation necessity determination means 62 determines whether the gradient of the servo pressure (change amount per unit time) (pressure gradient) should be limited in order to suppress the overshoot or the undershoot of the servo pressure based on the target servo pressure (corresponds to the “target master pressure”) and the actual servo pressure. The target servo pressure is a target value of the servo pressure set according to the operation amount of the brake pedal 10 (or according to the required braking force). The servo pressure is correlated with the master pressure, and the target servo pressure can also be said to be a target master pressure (target value of the master pressure). That is, the control based on the target servo pressure has the same meaning as control based on the target master pressure. The brake ECU 6 (control means 61) determines a target servo pressure corresponding to the operation amount from the stored map. The actual servo pressure is a value (actual-master-pressure correlation value) correlated with the actual master pressure that is an actually detected master pressure. The actual-master-pressure correlation value may be an actual master pressure (e.g., a pressure sensor provided on the pipe 51 or the pipe 52) or a wheel pressure.

Specifically, the limitation necessity determination means 62 determines whether the difference (deviation) between the target servo pressure and the actual servo pressure is less than a predetermined threshold value. The limitation necessity determination means 62 stores a first threshold value as a threshold value at the time of pressure increase and stores a second threshold value as a threshold value at the pressure reduction. The limitation necessity determination means 62 determines that “the gradient of the servo pressure should be limited” when the difference between the target servo pressure and the actual servo pressure is less than the first threshold value at the time of pressure increase. Furthermore, the limitation necessity determination means 62 determines that “the gradient of the servo pressure should be limited” when the difference between the target servo pressure and the actual servo pressure is less than the second threshold value at the time of pressure reduction. That is, the limitation necessity determination means 62 determines whether the gradient of the servo pressure should be limited (should be reduced) based on the difference between the target servo pressure and the actual servo pressure. In the first embodiment, the first threshold value and the second threshold value are set to the same value. The limitation necessity determination means 62 determines whether the gradient of the servo pressure should be limited to suppress the overshoot or the undershoot.

The control means 61 opens the pressure reducing valve 41 when the limitation necessity determination means 62 determines that the gradient of the servo pressure should be limited during the brake control. That is, the control means 61 makes the control current applied to the pressure reducing valve 41 smaller than the valve opening current of the pressure reducing valve 41. Thus, the pressure reducing valve 41 is changed from the closed state to the opened state, and in the first pilot chamber 4D, the operation fluid (operation fluid) flows in through the pressure increasing valve 42 and the operation fluid flows out through the pressure reducing valve 41. Therefore, the pressure increasing gradient of the pilot pressure is reduced, and as a result, the pressure increasing gradient of the servo pressure is also reduced. When the difference between the target servo pressure and the actual servo pressure is less than the first threshold value, that is, when the actual servo pressure is close to the target servo pressure, the gradient of the servo pressure become small so that the hysteresis amount decreases and the overshoot is suppressed.

The control means 61 sets the opening degree (control current) of the pressure reducing valve 41 based on the difference (first threshold value here) between the target servo pressure and the actual servo pressure at the time of determination by the limitation necessity determination means 62 by a map and the like. That is, the control means 61 increases the opening degree of the pressure reducing valve 41 to further increase the reduction degree of the pressure increasing gradient when the difference is small, and decreases the opening degree of the pressure reducing valve 41 to reduce the reduction degree of the pressure increasing gradient when the difference is large. In the first embodiment, determination is made that “the gradient should be limited” when the difference becomes less than the first threshold value, and hence the pressure reducing valve 41 is controlled at an opening degree corresponding to the first threshold value. However, after the determination that “the gradient should be limited”, the control means 61 may calculate the difference between the target servo pressure and the actual servo pressure every predetermined time, and set to change the opening degree of the pressure reducing valve 41 according to the calculated difference. Furthermore, the control means 61 sets the valve opening time of the pressure reducing valve 41 based on the difference between the target servo pressure and the actual servo pressure (first threshold value here). The valve opening time is also set to be smaller as the difference is larger and to be larger as the difference is smaller. The valve opening time may be updated every predetermined time. Moreover, although the control means 61 attempts to open the pressure reducing valve 41 for the valve opening time, if the actual servo pressure enters the dead zone during the valve opening time, the pressure reducing valve 41 is also switched to the maintaining control (closed) at the time point.

The hysteresis amount is a change amount of the servo pressure that still changes even when the pressure increasing control or the pressure reducing control of the servo pressure is ended (even when switched to the maintaining control). The maintaining control is a control for having the pressure reducing valve 41 and the pressure increasing valve in the closed state. When switched from the pressure increasing control, that is, a state where the control piston 445 pushes the ball valve 442 to bring the first chamber 4A and the second chamber 4B into communication (the control piston 445 is at the pressure increasing position) to the maintaining control, that is, a state where the pressure reducing valve 41 and the pressure increasing valve 42 are closed and the first pilot chamber 4D is in a sealed state, the hysteresis occurs, for example, when the pressure increasing state is continued from when the control piston 445 retracts from the pressure increasing position until when the first chamber 4A and the second chamber 4B are shut off. As the gradient of the servo pressure, that is, the gradient of the pilot pressure becomes larger, the control piston 445 moves forward, and the time to move backward after switching to the maintaining control becomes longer, and the hysteresis amount becomes larger. Conversely, as the gradient of the servo pressure becomes smaller, the hysteresis amount becomes smaller.

Furthermore, in the control means 61, a dead zone for the target servo pressure is set. The dead zone is set to the positive side and the negative side with respect to the target servo pressure. The control means 61 switches the brake control to the maintaining control when the actual servo pressure becomes a value within the range of the dead zone. That is, when performing the brake control, the control means 61 recognizes that the actual servo pressure has substantially reached the target servo pressure when it falls within the range of the dead zone (dead zone region). Hunting of fluid pressure control can be suppressed by setting such a dead zone more than when setting the target servo pressure at one point.

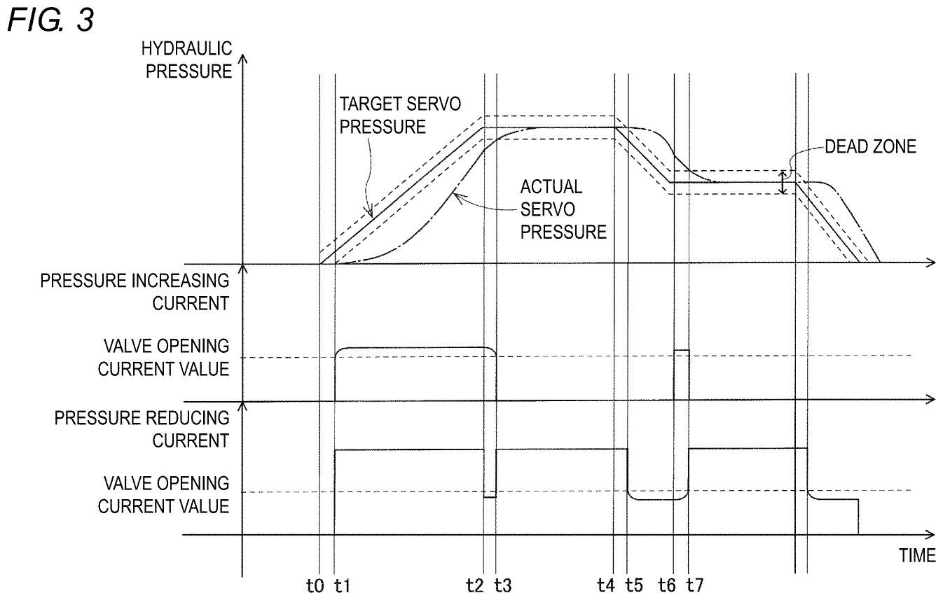

The gradient limitation control of the first embodiment will be described by way of an example. As shown in FIG. 3, at to, the brake pedal 10 is operated and the increasing of the target servo pressure is started. At t1, the actual servo pressure falls outside the dead zone, and the brake control (feedback control: FB control) based on the difference between the target servo pressure and the actual servo pressure is started. That is, at t1, a control current larger than the valve opening current is applied to the pressure increasing valve 42 to open the pressure increasing valve 42, and a control current larger than the valve opening current is applied to the pressure reducing valve 41 to close the pressure reducing valve 41. From t1 to t2, the servo pressure increases with the pressure increasing gradient based on the feedback control. Slightly before t2, the target servo pressure becomes constant according to the brake operation.

At t2, the difference between the target servo pressure and the actual servo pressure becomes less than the first threshold value, the limitation necessity determination means 62 determines that “the gradient should be limited”, and the pressure reducing valve 41 is opened. That is, at t2, a control current less than the valve opening current is applied to the pressure reducing valve 41 to open the pressure reducing valve 41. At t2, the opening degree of the pressure increasing valve 42 is controlled by the control means 61 so that the servo pressure has a predetermined gradient (0<predetermined gradient<gradient at t2). Here, a control current applied to the pressure increasing valve 42 is gradually lowered. At t3, the actual servo pressure falls within the dead zone, and the control mode becomes the maintaining control. That is, at t3, a control current less than the valve opening current (here, 0) is applied to the pressure increasing valve 42 to close the pressure increasing valve 42, and a control current larger than the valve opening current is applied to the pressure reducing valve 41 to close the pressure reducing valve 41. After t3, a hysteresis corresponding to the pressure increasing gradient of the servo pressure at t3 is generated, and the actual servo pressure approaches the target servo pressure.

After the occurrence of hysteresis, the servo pressure is maintained, and at t4, the target servo pressure decreases according to the brake operation. At t4 to t5, the actual servo pressure is within the dead zone, and thus the maintaining control is continued. At t5, the actual servo pressure is located outside the dead zone, and the pressure reducing valve 41 is opened by the feedback control. That is, at t5, a control current less than the valve opening current is applied to the pressure reducing valve 41, and the pressure reducing valve 41 is opened. At t6, the difference between the target servo pressure and the actual servo pressure becomes less than the second threshold value, the limitation necessity determination means 62 determines that “the gradient should be limited”, and the pressure increasing valve 42 is opened. That is, at t6, a control current larger than the valve opening current is applied to the pressure increasing valve 42.

From t6 to t7, the control current of the pressure reducing valve 41 is gradually increased, and the opening degree of the pressure reducing valve 41 is controlled so that the servo pressure has a predetermined gradient (gradient at t6<predetermined gradient<0). At t7, the actual servo pressure falls within the dead zone, and the control mode becomes the maintaining control. After t7, hysteresis occurs and the actual servo pressure approaches the target servo pressure. Thereafter, the same control as described above is performed.

According to the first embodiment, when the actual servo pressure approaches the target servo pressure, the pressure reducing valve 41 is opened if the pressure increasing control is being performed, and the pressure increasing valve 42 is opened if the pressure reducing control is being performed. The gradient of the servo pressure is thereby reduced, and the hysteresis amount that is generated can be reduced thus suppressing the overshoot or the undershoot.

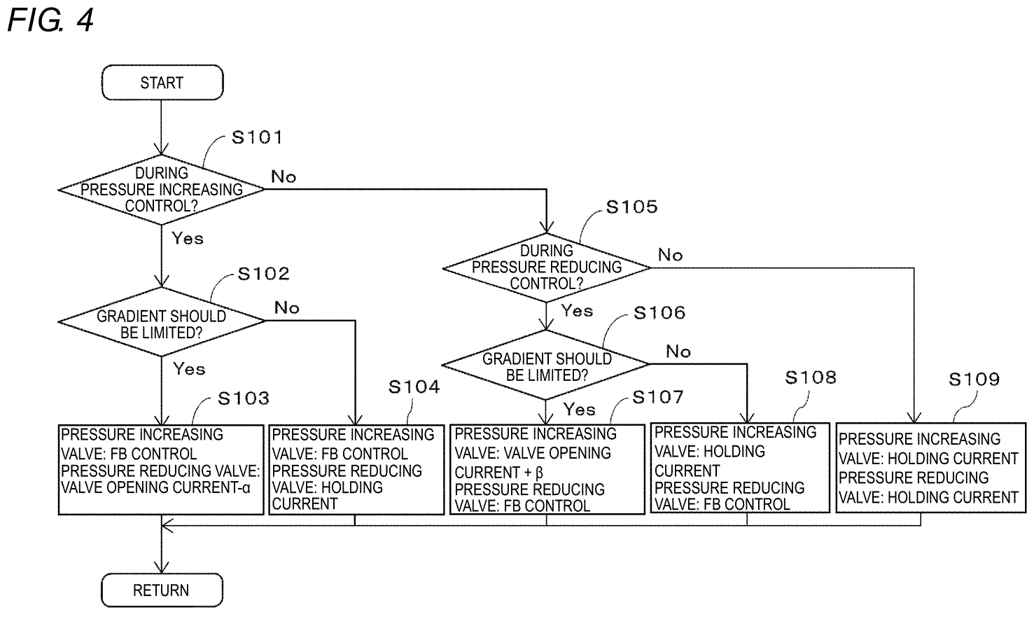

The flow of the gradient limitation control in accordance with the first embodiment will be described. As shown in FIG. 4, when the pressure increasing control is being performed (S101: Yes), whether the gradient of the servo pressure (pressure increasing gradient) should be limited is determined (S102). When determined that the gradient of the servo pressure should be limited (S102: Yes), the control current (indication value) to the pressure increasing valve 42 becomes a value obtained by adding the feedback current (hereinafter referred to as “FB current”) to the valve opening current, and the control current to the pressure reducing valve 41 becomes a value obtained by subtracting a predetermined value from the valve opening current (valve opening current—α) (S103). The FB current is a current value determined based on the difference between the target servo pressure and the actual servo pressure. When determined that the gradient of the servo pressure should be limited (S102: No), the control current to the pressure increasing valve 42 becomes the FB current, and the control current to the pressure reducing valve 41 becomes the holding current (current to be in the valve closed state) (S104).

When the pressure reducing control is being performed (S101: No, S105: Yes), whether the gradient of the servo pressure (pressure reducing gradient) should be limited is determined (S106). When determined that the gradient of the servo pressure should be limited (S106: Yes), the control current to the pressure increasing valve 42 becomes a value obtained by adding a predetermined value to the valve opening current (valve opening current+β), and the control current to the pressure reducing valve 41 becomes the valve opening current+FB current (S107). When determined that the gradient of the servo pressure should be limited (S106: No), the control current to the pressure increasing valve 42 becomes the holding current, and the control current to the pressure reducing valve 41 becomes the valve opening current+FB current (S108). When the maintaining control is being performed (S101: No, S105: No), the control current to the pressure increasing valve 42 and the pressure reducing valve 41 becomes the holding current (S109). The brake ECU 6 executes the gradient limitation control at predetermined time (or constantly). In the first embodiment, α=β.

According to the first embodiment, when the actual servo pressure approaches the target servo pressure during the pressure increasing control, the pressure reducing valve 41 is opened to limit the pressure increasing gradient of the servo pressure. The hysteresis amount is thereby suppressed and the overshoot is suppressed. Furthermore, according to the first embodiment, since the pressure increasing gradient can be reduced by opening the pressure reducing valve 41 during the pressure increasing control, the overshoot can be suppressed even if a large pressure increasing gradient is realized until the actual servo pressure approaches the target servo pressure. Therefore, the actual servo pressure can be quickly brought close to the target servo pressure while suppressing the overshoot. When the pressure reducing valve 41 is opened during the pressure increasing control, the pressure increasing valve 42 may be closed. The pressure increasing gradient thus can be more rapidly reduced.

Similarly, according to the first embodiment, when the actual servo pressure approaches the target servo pressure during the pressure reducing control, the pressure increasing valve 42 is opened to limit the pressure reducing gradient of the servo pressure. The hysteresis amount is thereby suppressed and the undershoot is suppressed. Thus, according to the first embodiment, the overshoot and the undershoot of the servo pressure can be suppressed.

### (Details of Drive Suppression Control)

Here, the control means 61 of the brake ECU 6 and the control thereof will be described in more detail. The control means 61 includes, as functions, a normal control unit 611, a drive suppression unit 612, and a suppression-level setting unit 613. As described above, the normal control unit 611 executes, on the basis of the actual servo pressure and the target servo pressure, the pressure increasing control that is control to increase the master pressure, the maintaining control that is control to maintain the master pressure, or the pressure reducing control that is control to reduce the master pressure. The drive suppression unit 612 executes the drive suppression control of suppressing the drive of the first and second master pistons 14 and 15 when the actual servo pressure approaches the target servo pressure while the normal control unit 611 is executing the pressure increasing control or the pressure reducing control. The drive suppression control corresponds to the gradient limitation control described above. When the pressure increasing gradient or the pressure reducing gradient is limited, the drive of the first and second master pistons 14, 15 during the pressure increasing control or the pressure reducing control is suppressed. The drive suppression unit 612 executes drive suppression control based on the suppression level set by the suppression-level setting unit 613.

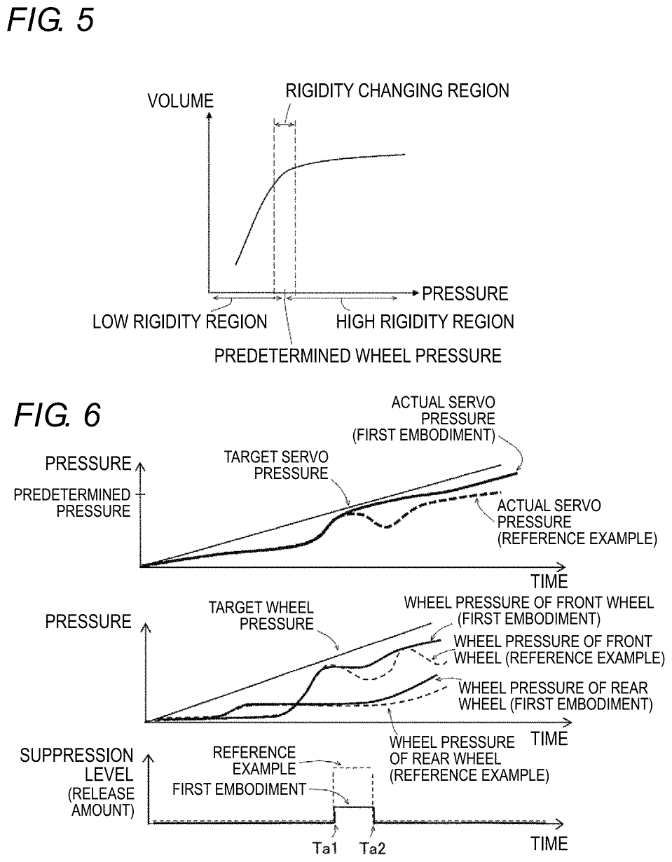

The suppression-level setting unit 613 sets the suppression level in the drive suppression control based on a rigidity of a downstream part X which is a part closer to the wheel cylinders 541 to 544 than the first and second master chambers 1D and 1E configured to include the wheel cylinders 541 to 544. The downstream part X mainly includes a pipe 51 connecting the first master chamber 1D and the wheel cylinders 543 and 544, a pipe 52 connecting the second master chamber 1E and the wheel cylinders 541 and 542, the wheel cylinders 541 to 544, and other devices (valves etc.). The rigidity of the pipes 51, 52 and the wheel cylinders 541 to 544 can be changed, for example, by changing the pressure on the inner side. For example, as shown in FIG. 5, the relationship between pressure and volume of the wheel cylinders 541 to 544 (hereinafter also referred to as “rigidity characteristic”) has at least two slopes. In a region where the pressure is relatively low, it can be said that the volume tends to relatively increase (the slope is relatively large) as the pressure increases, and the rigidity is relatively small. On the contrary, in a region where the pressure is relatively high, it can be said that the slope is relatively small and the rigidity is relatively large. The magnitude of rigidity corresponds to the magnitude of slope in the pressure-volume relationship.

The suppression-level setting unit 613 sets the suppression level in accordance with the high and low (magnitude) of the rigidity of the downstream part X. The suppression level can also be said to be, for example, the total reduction amount of the operation fluid flowing into or out of the first and second master chambers 1D, 1E. The rigidity can be estimated based on at least one of the values of the pressure in each of the pipes 51 and 52, the pressure in each of the wheel cylinders 541 to 544 (wheel pressure), and the actual servo pressure (actual-master-pressure correlation value). That is, the suppression-level setting unit 613 can use one or more of these values (e.g., the pressure in the pipe 51, the wheel pressure of the wheel cylinder 541, or the actual servo pressure, etc.) as a determination element for high and low of the rigidity. The suppression-level setting unit 613 can set the suppression level based on information (rigidity information) related to the rigidity of the downstream part X, such as for example, the actual servo pressure and the wheel pressure (estimated wheel pressure etc.). That is, the suppression-level setting unit 613 can determine the high and low of the rigidity based on at least one of the actual-master-pressure correlation value, the wheel pressure, and the pressure of the downstream part X.

The suppression-level setting unit 613 of the first embodiment uses the actual servo pressure as a determination element of the rigidity. The actual servo pressure is correlated with the actual-master pressure, and the actual-master pressure is correlated with the pressure of the downstream part X. Each wheel pressure can be estimated based on, for example, the information on rigidity characteristics, the actual servo pressure, and the control state. Furthermore, when the pressure sensor for measuring the wheel pressure is provided, the measurement value can be used as the wheel pressure.

The suppression-level setting unit 613 according to the first embodiment determines whether the actual servo pressure is less than or equal to a predetermined pressure. The predetermined pressure in the first embodiment is a preset value, and is set based on the rigidity characteristic of one of the wheel cylinders 541 to 544. Specifically, as shown in FIG. 5, the “predetermined pressure” is a value of the servo pressure corresponding to the “predetermined wheel pressure” set within a region where the rigidity of the wheel cylinder 541 greatly changes, that is, a region (rigidity changing region) where the slope in the rigidity characteristics changes by greater than or equal to a predetermined value. The servo pressure (master pressure) and wheel pressure correspond.

The slope (the proportion of volume change with respect to pressure change) in FIG. 5 is large on the low pressure side and small on the high pressure side, and the two slopes are connected by a curve. The predetermined wheel pressure is set to a value within the rigidity changing region which is a curved part. Thus, the region where the wheel pressure is less than or equal to the predetermined wheel pressure can be said to be a “low rigidity region” where the rigidity is relatively low, and the region where the wheel pressure is higher than the predetermined wheel pressure can be said to be a “high rigidity region” where the rigidity is relatively high. When the rigidity characteristic is entirely represented by a curve, for example, a point (or a point in the vicinity thereof) at which the change amount in the slope of a tangent becomes greater than or equal to a predetermined value can be set as the predetermined wheel pressure. Furthermore, for example, the predetermined pressure may be set in consideration of the rigidity of the entire downstream part X, or may be set in consideration of the rigidity of one or more of a plurality of pipe systems connecting the master chamber and the wheel cylinders 541 to 544. Moreover, the predetermined wheel pressure may be set outside the rigidity changing region. In addition, as in the first embodiment, one of the wheel cylinders 541 to 544 may be selected, and the predetermined wheel pressure may be set based on the rigidity of the selected wheel cylinder. FIG. 5 is an example of the rigidity characteristics of a wheel cylinder of a disk brake device.

When the actual servo pressure is less than or equal to the predetermined pressure, the suppression-level setting unit 613 makes the suppression level smaller than when the actual servo pressure is not less than or equal to the predetermined pressure. For example, when the pressure increasing control is being performed, the suppression-level setting unit 613 sets the opening degree of the pressure reducing valve 41 small in the drive suppression control (pressure increasing gradient limitation control). The suppression-level setting unit 613 sets the value of the control current (e.g., magnitude of a above) so that the opening degree of the pressure reducing valve 41 in the drive suppression control (pressure increasing gradient limitation control) becomes smaller than the opening degree when the actual servo pressure is higher than the predetermined pressure. That is, when executing the drive suppression control at the time of the pressure increasing control when the actual servo pressure is less than or equal to a predetermined pressure, the drive suppression unit 612 executes the drive suppression control by the suppression level smaller than the suppression level (release amount) when the actual servo pressure is higher than the predetermined pressure.

In the first embodiment, the execution time of the drive suppression control (the valve opening time of the pressure reducing valve 41) is constant, and thus the total amount of leakage of the operation fluid from the pressure reducing valve 41 during the pressure increasing control is reduced. Similarly, during the pressure reducing control, the suppression-level setting unit 613 sets the opening degree of the pressure increasing valve 42 small in the drive suppression control (pressure reducing gradient limitation control). This also reduces the total amount of operation fluid flowing in from the pressure increasing valve 42 during the pressure reducing control. The suppression-level setting unit 613 may reduce the suppression level by reducing the execution time (valve opening time) of the drive suppression control.

Here, an example of the drive suppression control (pressure increasing gradient limitation control) will be described. In FIG. 6, the “reference example” represents the control result by the control in which the suppression level is constant regardless of the rigidity, and the “first embodiment” represents the control result by the control in which the suppression level is set by the suppression-level setting unit 613 based on the rigidity. In this example, the disk brake device is mounted on the front wheels 5FR, 5FL, and the drum brake device is mounted on the rear wheels 5RR, 5RL. Furthermore, hereinafter, in the description, the opening degree of the pressure reducing valve 41 in the drive suppression control when the actual servo pressure is higher than the predetermined pressure is referred to as “normal opening degree”, and the suppression level at that time is referred to as “normal suppression level”.

As shown in FIG. 6, the drive suppression control is executed at Ta1, but at this time, the suppression-level setting unit 613 sets the suppression level smaller than the normal suppression level since the actual servo pressure is less than or equal to a predetermined pressure. Therefore, during a predetermined time (Ta1 to Ta2) in which the drive suppression control is executed, the opening degree of the pressure reducing valve 41 becomes smaller than the normal opening degree, and the release amount of the operation fluid flowing out from the servo chamber 1A to the reservoir 171 through the pressure reducing valve 41 also becomes smaller than the time of normal opening degree. Thus, the actual servo pressure increases along the target servo pressure without suddenly decreasing after approaching the target servo pressure. Accompanying therewith, the wheel pressure of the wheel cylinders 541 and 542 on the front wheels 5FR and 5FL side also increases along the target servo pressure (target wheel pressure) without suddenly decreasing. The increasing (rising) timing of the wheel pressure of the wheel cylinders 543 and 544 of the rear wheels 5RR and 5RL also becomes early.

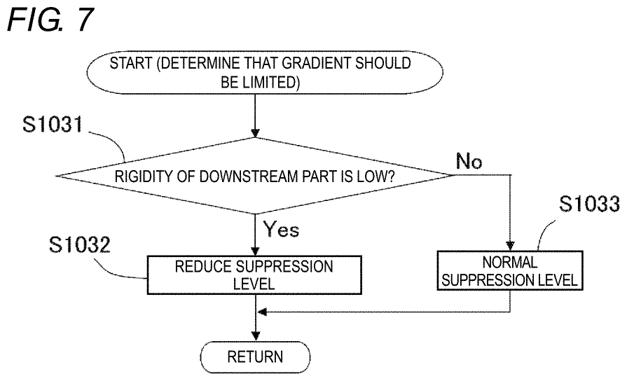

Here, the detailed flow of the drive suppression control (gradient suppression control) will be described with reference to FIGS. 4 and 7 taking the time of pressure increasing control as an example. FIG. 7 shows the step of S103 of FIG. 4 in detail. As shown in FIG. 7, when determined that the gradient should be limited (S102 in FIG. 4: Yes), the suppression-level setting unit 613 determines whether the rigidity of the downstream part X is smaller than a predetermined value, for example, whether the actual servo pressure is less than or equal to a predetermined pressure in the first embodiment (S1031). When the actual servo pressure is less than or equal to a predetermined pressure (S1031: Yes), the suppression-level setting unit 613 sets the suppression level to a value smaller than the normal suppression level, and the drive suppression unit 612 executes the drive suppression control based on the set value (S1032).

On the other hand, when the actual servo pressure is higher than the predetermined pressure (S1031: No), the suppression-level setting unit 613 sets the suppression level to the normal suppression level (e.g., without changing from the suppression level set in advance) and the drive suppression unit 612 executes the drive suppression control based on the set value (S1033). The detailed flow of the drive suppression control of the first embodiment is obtained by replacing S103 of FIG. 4 with S1031 to S1033 of FIG. 7. Similarly, with regard to drive suppression control during the pressure reducing control, a detailed flow can be obtained by replacing S107 with the rigidity determination step (corresponds to S1031) and the suppression-level setting step (corresponds to S1032 and S1033).

According to the first embodiment, as shown in FIG. 6, the movement of the first and second master pistons 14 and 15 is suppressed from stopping as the suppression level of the drive suppression control is reduced when the rigidity of the downstream part X is low. When the movement of the first and second master pistons 14 and 15 is stopped during pressure increasing control while the rigidity of the downstream part X is low, wraparound of the operation fluid may occur by the fluid pressure difference among the plurality of wheel cylinders 541 to 544 connected to the first and second master chambers 1D and 1E. That is, the wheel pressure of the wheel cylinders 541 to 544 on the relatively high pressure side may be reduced. In the first embodiment, since the suppression level for suppressing the movement (drive) of the first and second master pistons 14 and 15 is set according to rigidity, the movement of the first and second master pistons 14, 15 is suppressed from stopping, and the occurrence of wraparound is suppressed. The fluctuation of the wheel pressure is thereby suppressed, and the wheel pressure can be brought closer to the target wheel pressure with high accuracy.

Furthermore, if the drive suppression control is executed with the normal suppression level when the rigidity of the downstream part X is low, the actual servo pressure tends to easily decrease as the volume of the downstream part X tends to easily increase, and a situation in which the pressure increasing control will be executed again may be obtained even if the pressure increasing control is shifted to the maintaining control. That is, control hunting may occur. However, according to the first embodiment, the suppression level is reduced when the rigidity of the downstream part X is low, and hence the occurrence of control hunting can be suppressed without the actual servo pressure greatly decreasing. That is, by executing the drive suppression control according to the rigidity, the wave of change in the actual servo pressure at the time of low pressure can be reduced, and the actual servo pressure can be brought close to the target servo pressure with higher accuracy.

Similarly, if the movement of the first and second master pistons 14 and 15 is stopped during the pressure reducing control when the rigidity of the downstream part X is low, the control may be adversely affected. However, according to the first embodiment, the suppression level is set so that the drive states of the first and second master pistons 14 and 15 are maintained, and thus an adverse effect on the control is suppressed. As described above, by setting the suppression level based on the rigidity of the downstream part X, the drive suppression control corresponding to the situation of the downstream part X is executed, rapid changes in the control target pressure are suppressed, and the control target pressure can be brought close to the target pressure with high accuracy.

Thus, the suppression-level setting unit 613 preferably reduces the suppression level as the rigidity of the downstream part X is lower. For example, “reducing the suppression level as the rigidity (actual servo pressure here) is lower” includes reducing the suppression level in a stepwise manner according to decrease in rigidity and reducing the suppression level functionally (e.g., linearly) according to the decrease in rigidity. In the first embodiment, the suppression level is changed in one step according to the rigidity, but may be changed in a stepwise manner in multiple steps by setting a plurality of different predetermined pressures or the like. Furthermore, the suppression level may be adjusted not only by the opening degree of the valve but also by the execution time of the drive suppression control (valve opening time of the valve). Moreover, the suppression-level setting unit 613 may set the suppression level to 0 when the rigidity of the downstream part X is low. That is, in this case, in the first embodiment, the drive suppression control is not executed when the actual servo pressure is less than or equal to a predetermined pressure. Similar effects as described above are also exhibited.

Furthermore, the configuration of the braking device to which the present invention can be applied merely needs to be a configuration in which the master chambers (1D, 1E) are caused to generate the master pressure by the drive of the master pistons (14, 15) and the plurality of wheel cylinders (541 to 544) connected to the master chambers (1D, 1E) are caused to generate the wheel pressure. The driving means of the first and second master pistons 14 and 15 may be, for example, a configuration for directly controlling the servo pressure without the intervention of the regulator 44 or a configuration including an electric booster for driving the first master piston 14. Furthermore, the rigidity characteristics of the downstream part X also differ depending on the type of brake device (disk brake device, drum brake device, etc.), and the predetermined pressure is preferably set in view of the pipe system and the connection relationship (e.g., front and back pipe and X pipe). Moreover, the predetermined pressure may be set in consideration of, for example, a state in which different types of brake devices are connected to the same pipe system.

### Second Embodiment

A vehicle braking device according to a second embodiment is different from the first embodiment in that the opening degree of the pressure reducing valve 41 during the pressure increasing control is set according to the “difference between the target servo pressure and the actual servo pressure” and the “gradient of the servo pressure”. The suppression-level setting unit 613 sets the suppression level (e.g., at least one of the opening degree of the valve and the valve opening time) based on the rigidity of the downstream part X, as in the first embodiment. Therefore, different portions will be explained.

The control means 61 sets the opening degree of the pressure reducing valve 41 in consideration of not only the difference (threshold value) between the target servo pressure and the actual servo pressure at the time of the determination by the limitation necessity determination means 62 but also the gradient of the servo pressure at the time of the determination by the limitation necessity determination means 62 (acquired from the pressure sensor 74). In the second embodiment, a map in which when the difference between the target servo pressure and the actual servo pressure and the gradient of the servo pressure are input, an appropriate opening degree (control current) of the pressure reducing valve 41 is output is stored in the control means 61. The map is set by experiments and calculations. When the difference between the target servo pressure and the actual servo pressure is the same for when the gradient of the servo pressure is large and for when the gradient is small, overshoot is more likely to occur when the gradient of the servo pressure is large. The control means 61 uses the map that takes such event into consideration, and controls the pressure reducing valve 41 so that the opening degree of the pressure reducing valve 41 becomes greater when the gradient of the servo pressure is large than when the gradient of the servo pressure is small even if the difference is the same.

As the opening degree of the pressure reducing valve 41 becomes larger, the flow rate of the operation fluid flowing out of the first pilot chamber 4D becomes larger, and the gradient of the pilot pressure (gradient of the servo pressure) can be reduced more quickly. According to the second embodiment, overshoot can be suppressed more accurately. The above control of the second embodiment can also be applied to the control of the pressure increasing valve 42 during the pressure reducing control.

### Third Embodiment

A vehicle braking device according to a third embodiment is different from the first embodiment in that the valve opening time of the pressure reducing valve 41 during the pressure increasing control is set based on the “difference between the target servo pressure and the actual servo pressure” and the “gradient of the servo pressure”. The suppression-level setting unit 613 sets the suppression level (e.g., at least one of the opening degree of the valve and the valve opening time) based on the rigidity of the downstream part X, as in the first embodiment. Therefore, different portions will be explained.

The control means 61 sets the valve opening time of the pressure reducing valve 41 during the pressure increasing control in consideration of not only the difference (threshold value) between the target servo pressure and the actual servo pressure at the time of the determination by the limitation necessity determination means 62 but also the gradient of the servo pressure at the time of the determination by the limitation necessity determination means 62 (acquired from the pressure sensor 74). In the third embodiment, a map in which when the difference between the target servo pressure and the actual servo pressure and the gradient of the servo pressure are input, an appropriate valve opening time of the pressure reducing valve 41 is output is stored in the control means 61. The map is set by experiments and calculations. When the difference between the target servo pressure and the actual servo pressure is the same for when the gradient of the servo pressure is large and for when the gradient is small, overshoot is more likely to occur when the gradient of the servo pressure is large.

The control means 61 uses the map that takes such event into consideration, and controls the pressure reducing valve 41 so that the valve opening time of the pressure reducing valve 41 becomes larger when the gradient of the servo pressure is large than when the gradient of the servo pressure is small even if the difference is the same. The flow rate of the operation fluid flowing out of the first pilot chamber 4D is determined by the opening degree of the pressure reducing valve 41 and the valve opening time. Therefore, the gradient of the servo pressure can be further reduced by increasing the valve opening time and increasing the flow rate of the operation fluid flowing out from the first pilot chamber 4D. According to the third embodiment, overshoot can be suppressed with more accuracy. The above control of the third embodiment can also be applied to the control of the pressure increasing valve 42 during the pressure reducing control.

### Fourth Embodiment

A vehicle braking device according to a fourth embodiment differs from the first embodiment in the method of determining the valve closing timing of the pressure reducing valve 41 that was opened during the pressure increasing control. The suppression-level setting unit 613 sets the suppression level (e.g., at least one of the opening degree of the valve and the valve opening time) based on the rigidity of the downstream part X, as in the first embodiment. Therefore, different portions will be explained.

When determined by the limitation necessity determination means 62 that the gradient of the servo pressure should be limited, the control means 61 monitors the change in actual servo pressure acquired by the pressure sensor 74 while gradually increasing the opening degree of the pressure reducing valve 41 and closes the pressure reducing valve 41 according to the change in the actual servo pressure. That is, the control means 61 gradually increases the opening degree of the pressure reducing valve 41 while monitoring the pressure sensor 74, and closes the pressure reducing valve 41 according to the change in the actual servo pressure.

For example, when the control means 61 gradually opens the pressure reducing valve 41 and detects that the gradient of the actual servo pressure has become smaller, the control means controls the pressure reducing valve 41 to the valve closing side and closes the pressure reducing valve 41. Alternatively, the control means 61 may be set to close the pressure reducing valve 41 when the gradient of the actual servo pressure becomes smaller than a predetermined gradient. The predetermined gradient may be set by the difference between the target servo pressure and the actual servo pressure. According to the fourth embodiment, rapid decrease of the servo pressure due to excessive opening of the pressure reducing valve 41 can be suppressed, and the pressure reducing valve 41 can be closed at an appropriate timing by monitoring the change in the actual servo pressure. According to the fourth embodiment, the actual servo pressure can be suppressed from becoming is too low relative to the target servo pressure. Furthermore, the overshoot can be suppressed with high accuracy according to the fourth embodiment. The above control of the fourth embodiment can also be applied to the control of the pressure increasing valve 42 during the pressure reducing control.

### Fifth Embodiment

The vehicle braking device of a fifth embodiment differs from the first embodiment in the control current applied to the pressure reducing valve 41 or the pressure increasing valve 42. The suppression-level setting unit 613 sets the suppression level (e.g., at least one of the opening degree of the valve and the valve opening time) based on the rigidity of the downstream part X, as in the first embodiment. Therefore, different portions will be explained.

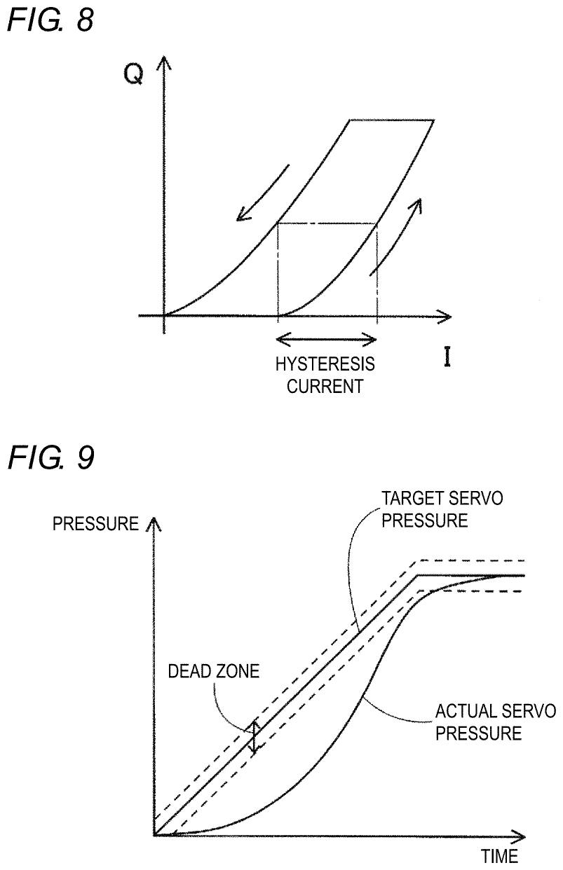

The control means 61 of the first embodiment applies, as a control current, a value obtained by adding the FB current to the valve opening current with respect to the pressure increasing valve 42 during the pressure increasing control. On the other hand, when the limitation necessity determination means 62 determines that “the gradient of the servo pressure should be limited” during the pressure increasing control, the control means 61 of the fifth embodiment applies, as a control current, a value obtained by subtracting the “hysteresis current” from a value obtained by adding the FB current to the valve opening current with respect to the pressure increasing valve 42. The hysteresis current is a value calculated from the hysteresis of the electromagnetic valve (pressure increasing valve 42), as shown in FIG. 8. The hysteresis current is based on the hysteresis between when increasing and when decreasing the flow rate.

Thus, when the actual servo pressure approaches the target servo pressure and the pressure increasing valve 42 is throttled in the future, the pressure increasing valve 42 can be throttled with satisfactory response. That is, overshoot can be suppressed with high accuracy by having the pressure increasing valve 42 easy to be throttled in advance. The control for subtracting the hysteresis current from the FB current is canceled when the pressure increasing control is switched to the maintaining control or when the pressure increasing control is started again. The above control of the fifth embodiment can also be applied to the control of the pressure reducing valve 41 during the pressure reducing control.

### Sixth Embodiment

A vehicle braking device according to a sixth embodiment is different from the first embodiment in that the valve opening control of the pressure reducing valve 41 during the pressure increasing control is used, together with the pressure increasing valve 42, for the pressure increasing gradient control of the servo pressure. The suppression-level setting unit 613 sets the suppression level (e.g., at least one of the opening degree of the valve and the valve opening time) based on the rigidity of the downstream part X, as in the first embodiment. Therefore, different portions will be explained.

First, the principle of control for suppressing overshoot or undershoot will be described. The brake ECU 6 controls the gradient or the flow rate of the pilot pressure by controlling the opening degree of the pressure reducing valve 41 and the pressure increasing valve 42, and as a result, controls the gradient of the servo pressure. Here, the difference between the actual servo pressure and the target servo pressure is referred to as a “target differential pressure”. Furthermore, the differential pressure in the regulator 44 is referred to as “regulator differential pressure”. The regulator differential pressure is a differential pressure between the pressure of the accumulator 431 (measurement value of the pressure sensor 75) and the actual servo pressure (measurement value of the pressure sensor 74) at the time of the pressure increasing control, and is the differential pressure between the atmospheric pressure (pressure of the reservoir 171) and the actual servo pressure at the time of the pressure reducing control.

Here, the equation of the flow rate is Q=C×(P)^{1/2}. Q is the flow rate (cc/s) of the regulator 44, C is a flow rate coefficient, and P is a regulator differential pressure. The flow rate coefficient C can be determined by the opening area and the fluid viscosity coefficient. The flow rate Q of the operation fluid flowing into and out of the servo chamber 1A can be obtained based on the hydraulic pressure gradient of the servo pressure and the rigidity (MPa/cc) of the servo chamber 1A. The opening area corresponds to the opening area of the flow path communicating the first chamber 4A and the second chamber 4B when the control piston 445 and the ball valve 442 are separated. That is, the flow rate coefficient C related to the opening area is obtained from the flow rate Q and the regulator differential pressure P. The opening area changes in accordance with the stroke of the control piston 445. Thus, the relationship between the stroke ST of the control piston 445, the regulator differential pressure P, and the flow rate Q (Q=f(ST, P)) can be obtained experimentally.

Thus, the stroke ST of the control piston 445 is obtained based on the flow rate Q and the regulator differential pressure P. The change volume (cc) is obtained from the stroke ST and the cross-sectional area of the control piston 445. Then, the hydraulic pressure change amount (pressure change amount) of the servo pressure due to the flow rate Q is obtained based on the change volume and the rigidity (MPa/cc) of the first pilot chamber 4D. That is, the hydraulic pressure change amount of the servo pressure in that state (hereinafter, also simply referred to as “hydraulic pressure change amount”) is calculated based on the current flow rate Q (the hydraulic pressure gradient of the current servo pressure) and the current regulator differential pressure P. When the flow rate (inflow/outflow amount) of the first pilot chamber 4D is made zero in a state of the flow rate Q and the regulator differential pressure P, the hydraulic pressure change amount corresponds to the amount of change in which the servo pressure changes by the movement of the control piston 445 thereafter. The movement of the control piston 445 after the first pilot chamber 4D is sealed is correlated with the flow rate of the operation fluid flowing into and out of the servo chamber 1A. That is, the amount of deviation (overshoot or undershoot) between the target servo pressure and the actual servo pressure caused by the conventional control is correlated with the flow rate (or gradient) of the operation fluid flowing into and out of the servo chamber 1A at the time point the target differential pressure becomes zero and the first pilot chamber 4D is sealed. The gradient of the servo pressure can be calculated based on the measurement value of the pressure sensor 74.

The relationship between the hydraulic pressure change amount of the servo pressure, the regulator differential pressure P, and the gradient (or flow rate Q) of the servo pressure can be obtained by calculation or experiment based on the above principle. These relationships are stored in the brake ECU 6 as a map. For example, when the current servo pressure gradient and the current regulator differential pressure P are input to the map, the hydraulic pressure change amount of the servo pressure corresponding thereto is output. The hydraulic pressure change amount corresponds to the change amount of the servo pressure generated by the movement of the control piston 445 when the first pilot chamber 4D is sealed to maintain the servo pressure (when the pressure reducing valve 41 and the pressure increasing valve 42 are closed) while the control state of the braking device is in the state of “current servo pressure gradient” and the “current regulator differential pressure P”. For example, when the actual pressure catches up with the target pressure in the state of “the current servo pressure gradient” and “the present regulator differential pressure P”, even if the first pilot chamber 4D is sealed to maintain the actual pressure, the actual pressure changes only with the “hydraulic pressure change amount”. That is, overshoot or undershoot occurs. Here, if the “hydraulic pressure change amount” which is the change amount of the actual pressure is the “target differential pressure”, theoretically, the actual pressure does not change beyond the target pressure even if the first pilot chamber 4D is sealed. That is, the “current servo pressure gradient” output by inputting the “current target differential pressure” and the “current regulator differential pressure P” as the “hydraulic pressure change amount” to the map is the gradient that causes the servo chamber 1A to change by the “current target differential pressure” when the first pilot chamber 4D is sealed with the hydraulic pressure gradient. The deviation of the actual pressure with respect to the target pressure, that is, overshoot or undershoot can be suppressed by using the hydraulic pressure change amount.

Here, taking brake control (FB control) at the time of pressure increase as an example, the control means 61 inputs the “target differential pressure” that can be calculated from the pressure sensor 74 and the “regulator differential pressure” that can be calculated from the pressure sensors 74 and 75 to the map, and the “servo pressure gradient” is output. The gradient of the servo pressure output here means the maximum gradient at which overshoot does not occur even if the actual servo pressure enters the dead zone at the current time point (even when switched to the maintaining control). Therefore, the control means 61 controls the pressure increasing valve 42 so that the pressure increasing gradient becomes less than or equal to the output servo pressure gradient at every predetermined time (or constantly). In consideration of catching up quickly, the control means 61 controls with the output “servo pressure gradient”.

Here, in the sixth embodiment, the control means 61 implements the pressure increasing control using not only the pressure increasing valve 42 but also the pressure reducing valve 41. The above map is created on the assumption that the pressure reducing valve 41 is closed in the pressure increasing control. On the other hand, in the sixth embodiment, since the pressure reducing valve 41 is used in the pressure increasing control, a map based on the principle described above (hereinafter referred to as “second map”) is created on the assumption that the pressure reducing valve 41 is opened (e.g., opening degrees a1, a2, . . . ) in pressure increasing control.

In the second map, the “servo pressure gradient” in a state in which the pressure reducing valve 41 is opened is output. In the second map, the pressure reducing valve 41 can be opened, and the pressure increasing gradient can be further reduced. Therefore, as shown in FIG. 9, in the control using the second map, the pressure increasing gradient of the servo pressure in the process of approaching the actual servo pressure to the target servo pressure can be increased. That is, according to the second map, the opening degree of the pressure increasing valve 42 can be increased.

Therefore, until the predetermined servo pressure or until the limitation necessity determination means 62 determines that “the gradient of the servo pressure should be limited”, the pressure increasing valve 42 is opened with the control current of the pressure increasing valve 42 corresponding to the gradient of the servo pressure output by the second map while having the pressure reducing valve 41 remained closed. Thus, the opening degree of the pressure increasing valve 42 becomes larger than in a case where the map is used, and the actual servo pressure can be brought closer to the target servo pressure more quickly. Then, when the predetermined servo pressure is reached (or when determined “to be limited”), the control means 61 opens the pressure reducing valve 41 to control the servo pressure to have a gradient at which an overshoot based on the above principle does not occur.

As described above, during the pressure increasing control, the control means 61 opens not only the pressure increasing valve 42 but also the pressure reducing valve 41 (by adjusting the opening degree) at every predetermined time (or constantly) to control the gradient of the servo pressure. Thus, the pressure increasing gradient can be increased to improve the responsiveness of the brake and to suppress the overshoot.

### Other Modifications

The present invention is not limited to the embodiments described above. For example, in the determination of the limitation necessity determination means 62, a pilot pressure may be used instead of the actual servo pressure. The pilot pressure may be a value converted from the actual servo pressure or a value measured directly by installing a pressure sensor. That is, the actual-master-pressure-related value merely needs to be a value related to the actual master pressure or the actual servo pressure, and may be a pilot pressure.

Furthermore, the timing of opening the pressure reducing valve 41 in the gradient limitation control may be when the FB current is decreased by a predetermined amount or when the gradient of the servo pressure is decreased by a predetermined amount. That is, the limitation necessity determination means 62 may determine whether the FB current has decreased by a predetermined amount or whether the gradient of the servo pressure has decreased by a predetermined amount.

Furthermore, the timing of closing the pressure reducing valve 41 in the gradient limitation control may be when the pressure sensor capable of measuring the pressure in the first pilot chamber 4D is installed, the pilot pressure is directly monitored, and the pilot pressure becomes a predetermined pressure. The predetermined pressure may be determined by the difference between the target servo pressure and the actual servo pressure. Furthermore, the limitation necessity determination means 62 may change the threshold value (first threshold value, second threshold value) in the gradient limitation control. The threshold value may be, for example, a value that changes according to the hysteresis estimated value. The hysteresis can be estimated from the target differential pressure, the gradient of the servo pressure, and the like according to the above principle. Furthermore, the first to fifth embodiments can be combined, and the second to sixth embodiments can be combined. Moreover, the suppression-level setting unit 613 may execute the determination of high and low of the rigidity based on, for example, at least one of the detected or estimated master pressure, the reaction force fluid pressure, and the stroke (value of the stroke sensor 71).

1. A vehicle braking device that drives a master piston of a master cylinder to generate wheel pressure in a plurality of wheel cylinders connected to a master chamber of the master cylinder,
the vehicle braking device comprising:
a normal control unit that executes a pressure increasing control that is a control of increasing the master pressure, a maintaining control which is a control of maintaining the master pressure, or a pressure reducing control that is a control of reducing the master pressure based on an actual-master-pressure correlation value correlated with an actual value of a master pressure that is a pressure in the master chamber and a target master pressure that is a target value of the actual-master-pressure correlation value;
a drive control unit that executes a drive suppression control for suppressing drive of the master piston when the actual-master-pressure correlation value approaches the target master pressure while the normal control unit is executing the pressure increasing control or the pressure reducing control; and
a suppression-level setting unit that sets a suppression level in the drive suppression control based on a rigidity of a downstream part that is a part on the wheel cylinder side than the master chamber configured to include the wheel cylinder.

2. The vehicle braking device according to claim 1, wherein the suppression-level setting unit reduces the suppression level as the rigidity is lower.

3. The vehicle braking device according to claim 1, wherein the suppression-level setting unit determines high and low of the rigidity based on at least one of the actual-master-pressure correlation value, the wheel pressure, and the pressure of the downstream part.

4. The vehicle braking device according to claim 2, wherein the suppression-level setting unit determines high and low of the rigidity based on at least one of the actual-master-pressure correlation value, the wheel pressure, and the pressure of the downstream part.
